(19) United States
(12) Patent Application Publication
(10) Pub. No.: US 2020/0226360 A1
(43) Pub. Date: Jul. 16, 2020

(54) System and method for automatically detecting and classifying an animal in an image

(71) Applicant: 9138-4529 QUEBEC INC., Victoriaville (CA)

(72) Inventors: Daniel Bouchard, Victoriaville (CA); Yan Gagnon, Victoriaville (CA); Joel Vinet, Victoriaville (CA)

(21) Appl. No.: 16/739,371

(22) Filed: Jan. 10, 2020

(30) Foreign Application Priority Data
Jan. 10, 2019 (CA) 3029643

(51) Int. Cl. G06K 9/00; G06N 20/00; H04N 5/232; G06T 7/207; G06K 9/78; A01M 31/00

(52) U.S. Cl. CPC G06K 9/00362; G06K 9/00771; G06N 20/00; A01M 31/002; G06T 7/207; G06K 9/00697; G06K 9/78; H04N 5/23222

(57) ABSTRACT

A system for automatically identifying and classifying an animal in an image which comprises a hunting camera or sensor, a remotely server, one or more client computerized devices and a network adapted to connect the camera, the remotely accessible computing device and the client computerized devices. The hunting camera captures images of a scene of a remote area to track animals. The images are communicated to the server which process the images to automatically detect animals and to automatically classify the species, type and/or characteristic associated with the detected animal.

### CROSS-REFERENCE TO RELATED APPLICATIONS

The present patent application claims the benefits of priority of Canadian Patent Application No. 3,029,643, entitled “SYSTEM AND METHOD FOR AUTOMATICALLY DETECTING AND CLASSIFYING AN ANIMAL IN AN IMAGE”, and filed at the Canadian Intellectual Property Office on Jan. 10, 2019, the content of which is incorporated herein by reference.

### FIELD OF THE INVENTION

The present invention generally relates to systems and methods for automatically detecting moving objects, such as vehicles, humans and/or animals in an image. More specifically, the present invention relates to surveillance systems such as hunting cameras adapted to capture images and to detects objects, humans and/or animals in such captured image.

### BACKGROUND OF THE INVENTION

Nowadays, hunting cameras are widely used in unattended areas, such as forest, to capture photos or images to track animals' activities. Existing hunting cameras generally comprise infrared or other sensing technology motion detectors to detect movement in the tracked area. The camera typically captures and stores the images on a storing unit embedded in the camera. The stored photographs are then retrieved by the user by physically accessing the camera. Retrieval of the images may be time consuming or even difficult in remote areas.

In other systems, the camera is adapted to transmit the captured image via a wireless network only when movement is detected.

Upon retrieving the images or photographs, the user must then analyze each captured image to identify animals or humans on the said captured images. Such process may be time consuming as the camera may capture a large number of images. Such manual identification also prevents or limits from easily identifying trends and movement occurrences with regard to a variety of parameters.

There is thus a need for an improved system for detecting and classifying animal in an image, such as automatically identifying the species in the image.

### SUMMARY OF THE INVENTION

The shortcomings of the prior art are generally mitigated by providing a System and a method for automatically detecting and classifying an animal in an image.

In one aspect of the invention, a system for automatically identifying and classifying a moving object in one or more images is provided. The system comprises a data network, an image capturing device installed to capture the one or more images of a scene at predetermined times, the image capturing device comprising a storage module configured to store the one or more captured images, a communication module configured to wirelessly communicate a remotely accessible computing device through the network. The system further comprises a remotely accessible computing device comprising a storage module, the remotely accessible computing device being configured to receive the one or more images captured by the image capturing device, to detect an animal in the received one or more images and to classify the detected moving object to identify characteristics and/or type of the detected moving object by calculating a probability of the characteristics and/or type of the detected moving object to be present in the one or more captured images.

The system may further comprise one or more client computerized devices, each client computerized device being configured to communicate with the remotely accessible computing device through the network, the remotely accessible computing device being further configured to send a notification upon identifying characteristics and/or type of the detected moving object. The remotely accessible computer device may be further configured to send the notification when the calculated probability is higher than a predetermined level. Each client computerized device may be further configured to download the one or more classified images. Each client computerized device may be further configured to filter the one or more classified image based on an identified characteristic and/or on an identified type.

The remotely accessible computing device may further comprise a machine learning module, the machine learning module being configured to store a large number of preselected images for which a moving object has been identified to train the classification of the detected moving object. The training of the detected moving object may be further configured to vary parameters of detections and to proceed to a large number of iterations by comparing the variation of parameters with the moving identified in the preselected images.

The image capturing device may further comprise a movement detector adapted to detect movement in the scene to be captured, the detection of movement triggering the image capturing device to capture an image of the scene.

The moving object may be an animal and the type being a species and the image capturing device may be a digital camera.

In another aspect of the invention, a computer-implemented method for automatically identifying and classifying a moving object in one or more image is provided. The method comprises capturing the one or more digital images of a scene using an image capturing device, communicating the captured image to a remote server, the remote server pre-processing the transmitted image, the remote server sending an image reception confirmation to the image capturing device, detecting presence of the moving object in the one or more communicated images and classifying the detected moving object to identify characteristics and/or type of the detected moving object by calculating a probability of the characteristics and/or type of the detected moving object to be present in the one or more captured images.

The method may further comprise detecting movement in the scene and capturing the one or more image only if movement is detected. The method may further comprise wirelessly communicating the stored images to the remote server at predetermined times upon detecting movement in the scene.

The method may further comprise storing the one or more captured images to a storage unit of the image capturing device and wirelessly communicating the stored images to the remote serve at predetermined times.

The method may further comprise validating if the captured image respects minimum requirements for detection and sending a command to the image capturing device to correct the one or more identified parameters of capturing process.

The method may further comprise sending a notification of an identified type and/or characteristic of the moving object to a remote client device.

The classification of the detected moving object may be automatically trained by a machine learning module. The method may further comprise storing a large number of preselected images for which a moving object has been identified to train the classification of the detected moving object. The method may further comprise varying parameters of classification and identification and proceeding to a large number of iterations by comparing the variation of parameters with the moving identified in the preselected images.

The method further comprising rating the one or more classified image as to the presence of the identified types or characteristics of the detected moving object and automatically adding the image having a positive rating to the preselected images for training purposes.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a block diagram showing a system for automatically detecting and classifying an animal in an image in accordance with the principles of the present invention.

FIG. 2 is a flow diagram showing a method to automatically detect and classify an animal in accordance with the principles of the present invention.

FIG. 3 is illustration of an embodiment of exemplary web interfaces for a user to trace a camera in accordance with the principles of the present invention.

FIGS. 4A and 4B are illustration of an exemplary embodiment of an interface showing the captured images with detected animal, respectively without and with applied filters in accordance with the principles of the present invention.

FIG. 5 is an illustration of an exemplary embodiment of an interface showing an image comprising a classified animal in accordance with the principles of the present invention.

FIG. 6 is a block diagram showing components of a remote server of a system for automatically detecting and classifying an animal in an image in accordance with the principles of the present invention.

### DETAILED DESCRIPTION OF THE PREFERRED EMBODIMENT

A novel system and method for automatically detecting and classifying an animal in an image will be described hereinafter. Although the invention is described in terms of specific illustrative embodiments, it is to be understood that the embodiments described herein are by way of example only and that the scope of the invention is not intended to be limited thereby.

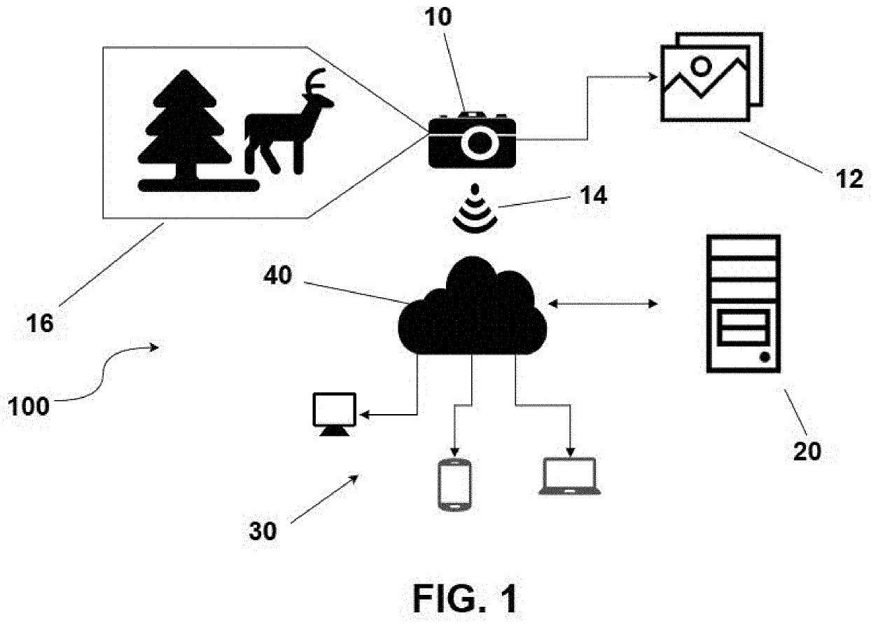

Referring first to FIG. 1, a system for automatically detecting and classifying an animal in an image 100 is shown. The system comprises a camera or sensor 10, a remotely accessible computing device 20, such as a computer or a server, one or more client computerized devices 30, such as a smart phone, a laptop, a tablet or any connected device adapted to communicate with the server 20 and a network 30 adapted to connect the camera 10, the remotely accessible computing device 20 and the client computerized devices 30, such as the Internet, a data cellular network, a LAN network, a wireless network, etc.

In some embodiments, the sensor 10 may be a digital camera or any computerized device comprising a module to capture images. The camera may further comprise a passive infrared sensor (PIR sensor). Understandingly, any other suitable sensor or device to capture an image known in the art may be used.

In yet other embodiments, the camera 10 is installed in a remote area to capture a scene or an area 16 where animals may be seen. The camera 10 is generally configured to capture images at predetermined intervals or frequencies or upon detection of movement using any known type of sensor. The camera 10 further comprises a storage unit 12 adapted to store the captured images. The camera also comprises a communication unit 14 adapted to wirelessly communicate with the network 40. Understandably, any type of communication unit 12 may be used such as mobile network access card or an embedded communication module. The communication unit may be configured to communicate with the network using any type of known, proprietary communication protocol or any application programming interface (API) such as REST or Json based APIs.

The camera 10 may be configured to capture images of subjects at a predetermined frequency in the context of hunting, general wildlife surveillance, security purpose or the like. In some embodiments, the PIR-based subject detector is operative to monitor the presence of a subject with a predetermined perimeter at a predetermined frequency to capture images. Preferably, when the photo has been transmitted to the server 20, the camera 10 may switch to a sleeping mode or may be disconnected. In some embodiments, a confirmation is sent from the server 20 to the camera 10 upon receiving the image 12 in order to trigger the camera 10 to switch to sleep mode or low-power mode.

In yet other embodiments, the camera 10 may be configured to capture two types of photographs 12 of the same scene 16, a daylight photograph in color and a nighttime photograph using a black and white infrared desaturated photo.

The camera 10 may further comprise a movement detector unit, such as infrared detector. When motion is detected, the movement detector unit sends a signal to the camera of capture an image 12. The image 12 is stored on a storage unit of the camera 10, such as an SD card or flash-based hard disk. The captured images 12 are then communicated to the server 20 through the network. Understandably, the camera 10 may be configured to automatically transmit the photos 12 to the server 20 using a wireless communication module 14. In embodiments where the camera 10 does not comprise a wireless communication module 14, the user may fetch the images 12 by physically accessing the camera (i.e. retrieving an SD card) and transferring the images 12 to the server 20 through the web server 27. In other embodiments, the camera 10 could also be configured to use the wireless communication module 14 to directly transmit the images 12 to the client computerized device 30.

The server 20 typically comprises a central processing unit or processor 21, a transient memory unit, a communication unit and a storage unit. The central processing unit is adapted to execute instructions to communicate with the camera 10, to obtain the captured image of the camera, to detect an animal in the captured image and to classify the detected animal of the image. The server 20 may further be configured to execute instructions to send a notification or the image comprising the classified animal to one or more client computerized devices 30. The server 20 is further configured to connect to the camera 10 and to the client computerized devices 30 through the network 40.

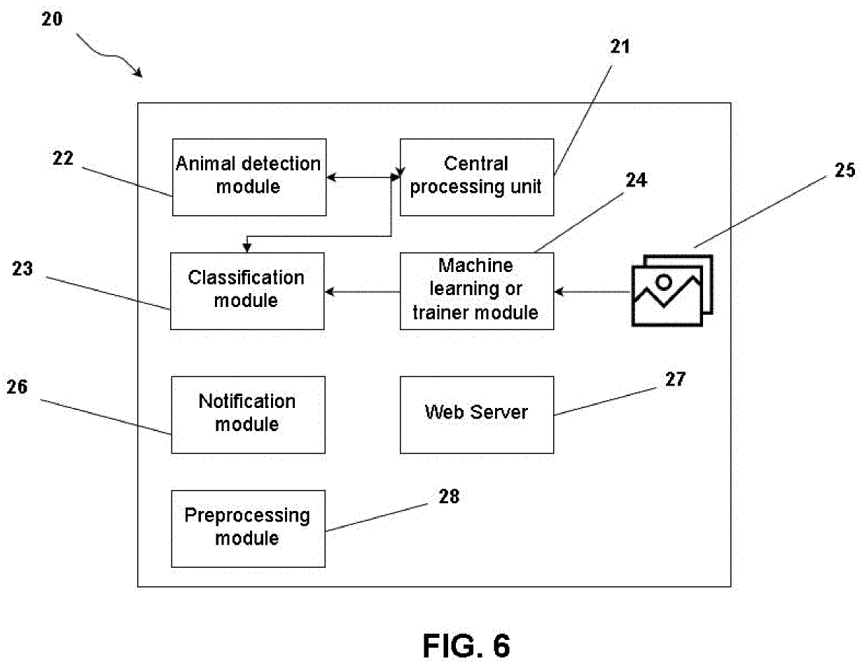

Now referring to FIG. 6, in some embodiments, the server 20 may comprise an animal detection module 22 and a classification module 23. The classification module 23 is fed by or uses a machine learning module 24. The machine learning module 24 uses a large number of images 25 to train the classification module 23.

The detection module 22 and the classification module 23 process and/or analyze the photos transmitted from the camera 10. The classification module 23 is configured to compare the detected animal and identify the species and/or the characteristics of the animal present on the image. The classification is preferably coupled to the machine learning module 24.

In some embodiments, the classification may identify more than one animal in the image or may identify more than one characteristic of each detected animal. As an example, the detected image may comprise two deer and a wild turkey. The classification module 23 is configured to classify each detected animal in the image and may identify one or more characteristics of each animal, each characteristic may be specific to each species or to each specific animal.

In some embodiments, the machine learning module 24 uses one or more neurons networks to detect, classify, recognize and/or verifying the animal in one or more image. The neurons network identifies the objects in the images and classify such objects from a list of predefined categories. As an example, to detect a deer comprising antlers or a panache, the classifying module 23 calculates the probability of the object being a deer. If the calculated probability if over a predetermined probability, the object will be classified as a deer. In some embodiments, the predetermined probability may be varied by the user to change the sensibility level of the system 100.

In yet some embodiments, the classifying module 23 transforms the image in one or more class from a predefined class hierarchy.

The machine learning module 24 is preferably configured to update the parameters of the classification module 23 in order to improve the classification process. In yet some other embodiments, the machine learning module 24 uses “data augmentation” technique to create new images based on the existing images 25. As examples, the machine learning module 24 may change the characteristics of the images, such as but not limited to moving pixels in the image, varying the colors or the saturation, etc. Such techniques allow the machine learning module 24 to process more images as the new photos are added to the images 25 fed to the machine learning module 24. Over time, as the machine learning module 24 uses more images 25, the precision of the classification module 23 is improved.

In yet other embodiments, the data storage comprising the images 25 may be populated by the images captured by one camera 10 or by a network of cameras 10. The machine learning module 24 may further uses manual techniques to improve the precision of the classification module 23, such as asking the users to manually classify the captured images or to validate, to identify a classification error or rate the classification executed by the classification module 23. Such validations or rating are then fed to the machine learning module 24 to generate new rules or parameters of classifications based on such feedback.

The camera 10 may further comprise a pre-classification module using a plurality of parameters from sensors of the camera 10 to classify the identify object, such as but not limited to the geo-localisation coordinates, temperature, variation of such temperature, moon phases, reference image, such as image taken by a fixed camera 10. Such pre-classification module in the camera 10 may be used to limit the data transmitted from the camera 10 as bandwidth is typically limited on such devices.

In some embodiments, the detection module 22 is configured to verify whether a new object or animal is present in the image by comparing to previously processed images using different environmental parameters.

The classification module 23 may be configured to divide the received images into at least two groups, one group comprising images with a detected object and the other group comprising images with no detected animal or object.

The classification module 23 of the server 20 may be further configured to classify detected animals based on their sex, on an estimate weight of the animal, on previous presences of the animal in the scene 16 or if the animal has particular diseases. The classification module 23 could also classify if a specific animal appears in another camera 10 or to identify other species which could have force one or more specific animals to move out of the area (i.e. coyotes, wolves, etc.). Such detected information is stored in a database so that the user can filter the image according to such identified characteristics.

The server 20 may further comprise a notification module 26 adapted to send prescheduled or spontaneous notifications through the network. As an example, the notification module 26 may send an email or a text message to a client computerized device 30 to alert of the presence of a specific species in front of the camera 10.

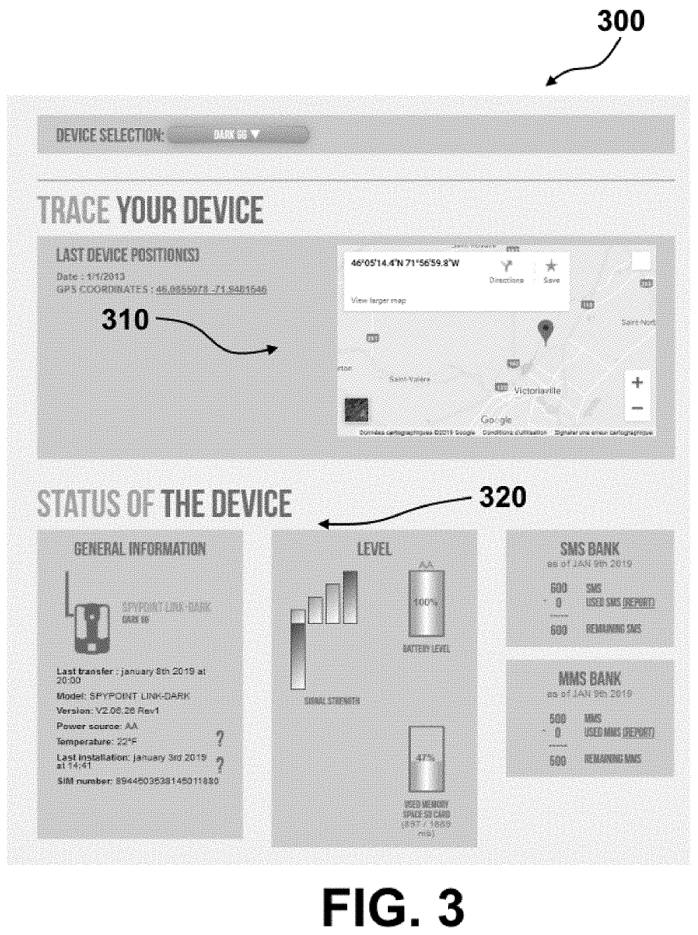

The server may further comprise a web server 27 adapted to send a web interface to the client computerized device 30 upon receiving a request by the said client computerized device 30. Such web interfaces are best shown at FIGS. 3, 4A, 4B and 5.

The server 20 may also comprise one or more pre-processing module 28 configured to communicate with the camera 10 and to identify if the capturing parameters are incorrect such as but not limited to the contrast, the saturation level, the colors, the exposition time, the compression level, the image resolution, etc. When such parameters are wrong, the server 20 is configured to send a command to the camera 10 to change such parameter in order to improve the detections and/or classification processes.

The server 20 may further be configured to process the received images in different first in first out queues. A first processing queue may transfer the captured image to the client computerized device 30 without any processing. A second queue may process the images exiting from the first processing queue. The server 20 is configured to send the images from the second queue to the detection module 22 and the classification module 23. The server 20 may further be configured to comprise a notification queue configured to send notifications to the client computerized device 30 based on predetermined settings of the client. As an example, one setting may be that the server 20 must process the detection and classification of the image before sending it to the client computerized device 30 or may send a notification only if a desired species is detected on the image.

The client computerized devices 30 typically comprise a central processing unit or processor, a transient memory unit, a communication unit and a storage unit. The central processing unit is adapted to execute instructions to receive notifications from the server 20 and to download one or more images comprising an animal through the network 40.

In use, the camera 10 captures a image of a predetermined areas or scene 16, the image is communicated to the server 20, the server 20 analyzes the communicated image to determine if an animal is present on the image, if an animal is found, the server 20 classifies the detected animal to identifies the species, such as a deer, a bear, a moose, a turkey, a kangaroo, etc. or any other characteristics of the detected animals, such as animal with or without antlers, size, weight, etc.

In some embodiments, the client computerized devices 30 may be configured to execute an application adapted to communicate with the server 20 through the network 40. The application may be configured to receive notifications of animal detection from the server 20, to download the images comprising detected animal or to set filter parameters to receive images or notifications for specific species or animal characteristics. The application may further be configured to set the way the notifications or images are sent to the user, such as by setting a predetermined interval of reception or by setting that the images are sent upon detecting an animal by the server 20. As an example, the application may be configured to receive detection results every 2 h, 4 h, 12 h or 24 h.

The application may further be configured to command the client computerized device 30 to communicate with the camera 10, directly or by sending a request to the server 20 to communicate with the camera 10. As an example, the application may be configured to communicate with the camera 10 or the server 20 to change one or more settings of the camera to adapt to different environments.

The application may further be adapted to input a rating in relation to the detection process of an animal in an image. As an example, the user could input that the detection was exact, that the identified species or characteristics of the animal is/are wrong.

Understandingly, in yet other embodiments, the application may be omitted and any other type of interface be used to communicate with the server, such as web interface or a graphical user interface for a computer configured to communicate with the server 20 and/or the camera 10. The said interface may comprise functions similar to the previously mentioned features of the application.

In some embodiments, the application may further be configured to select or click on a receive notification to automatically download and display the image having the predetermined characteristics.

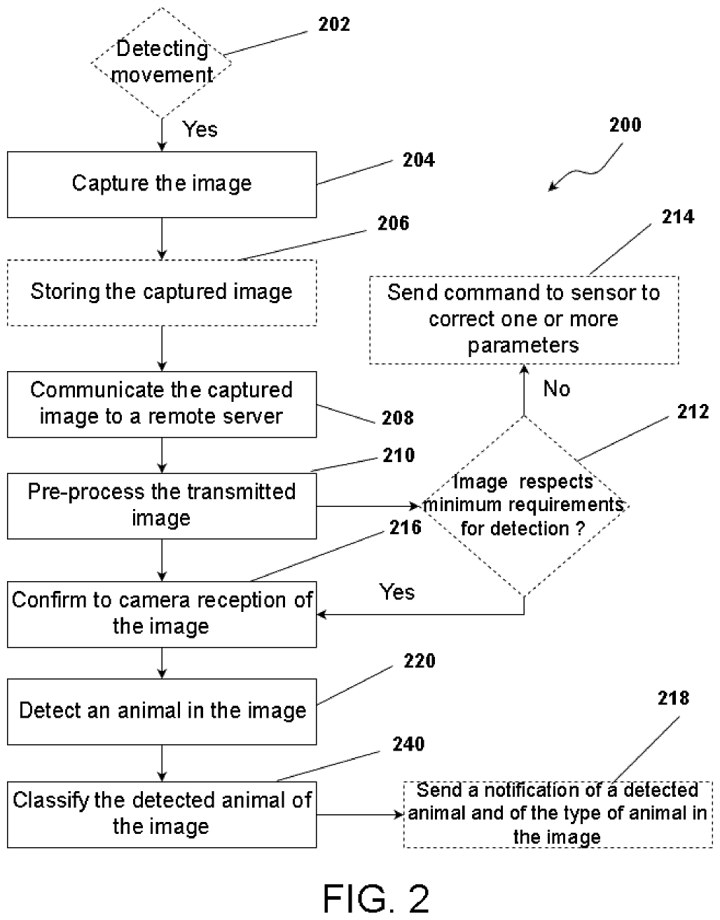

Now referring to FIG. 2, a method to automatically detect and classify an animal or characteristics in an image 200 is shown. The method 200 comprises capturing an image of a scene 204, communicating the captured image to a remote server 208, the server pre-processing the transmitted image 210, the server confirming to the capturing mean the reception of the image 216, detecting an animal in the image 220 and classifying the detected animal of the image 240.

The method 200 may further comprise detecting movement in the scene 202 and capturing the image 204 only if movement is detected. The movement may be detected 202 using any known technique or mechanism, such as using an infrared sensor.

The method 200 may further comprise storing the captured image 206 to a storage unit of the camera 10. In such embodiments, the method 202 may further comprise communicating the stored images to the server 208 at predetermined intervals, at predetermined times of the day or upon detecting movement 202 in the scene 16.

The method 200 may further comprise validating if the captured image respects minimum requirements for detection 212. Such minimum requirements may comprise but not limited to the contrast, the saturation level, the colors, the exposition time, the compression level, the image resolution, etc. If the minimum requirements are not respected or met 212, the method 200 may further comprise sending a command to the camera 10 to correct the one or more identified parameters of the camera 10. Typically, such captured image may be deleted or discarded.

The method 200 may further comprise sending a notification of a detected animal and/or of the type of species or of specific characteristics of an animal detected in the image 218.

The step to detect an animal in the image 220 may further comprise identifying whether movement is detected in the scene 204 by comparing with previous image identified with no movement. If movement is identified, the method 200 compares the presently captured image with the previous non-movement image to identify the contours of an animal. The coordinates of the contours of the animals are then used by the step to find the species of the animal or of characteristics of the animals 240.

In a preferred embodiment, the classification of the detected image 240 uses a trained machine learning module to classify the animal based on characteristics identified during the training process of the machine learning module.

The present disclosure further comprises a method to train the classification module using a machine learning module. The method of training comprises updating the parameters of the classification in order to improve the classification process. The method of training may further comprise using “data augmentation” technique to create new images based on the existing images. As examples, the method of training may comprise changing the characteristics of the images, such as but not limited to moving pixels in the image, varying the colors or the saturation, etc. Such techniques allow the method of training to process more images as the new photos are added to the images used to identify the characteristics or species of animals.

The method to train the classification process may comprise feeding to the training module a large number of preselected images for which the result is known (i.e. a deer is present, a white rabbit is present, etc.). The method to train the classification process may further comprise changing the parameters of detections and proceed to a large number of iterations by comparing the variation of parameters with the known answers or result. The method thus learns from such variation and stores the resulting working variation of parameters.

The method to train the classification module may further comprise storing a large number of images taken or captured by one camera 10 or by a network of cameras 10. The method to train the classification module may further comprise manually inputting evaluation or identification of characteristics or species of animal found in the stored images to improve the precision of the classification step 240. In some embodiments, the method may comprise requiring a user to classify the captured images or to validate, to identify a classification error or to rate the classification executed by the classification step 240. Such validations or ratings are then used by the training method to generate new rules or parameters of classifications based on such feedback. In such embodiments, the training method may further comprise automatically adding the image for which feedback to the images for training purposes. Such images shall be associated with a high level of confidence (score) in order for the training method to use the image as a preselected image.

Understandably, the classification module may be trained using any training method known in the art.

Referring now to FIGS. 3, 4A-4B and 5, an embodiment of exemplary web interfaces generated by a web server 26 are shown. Referring first to FIG. 3, an interface 300 for the user to trace the camera 10 is shown. The interface 300 typically comprises a geo-localisation module 310 adapted to display the coordinates of the position of the camera 10, such as a map or as coordinates of the position. The device interface 300 may further comprise an area displaying the status of the camera 320. The status 320 may comprise the battery level of the camera, the remaining space on the storage device, the model of the camera, the external temperature or any relevant statistics of usage of the camera 10.

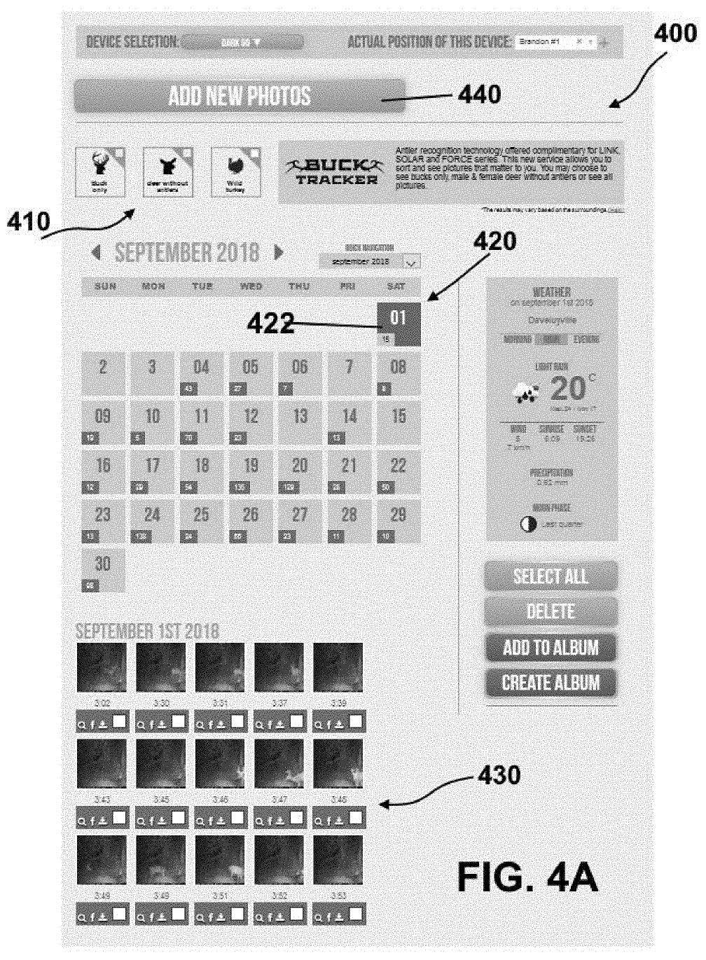

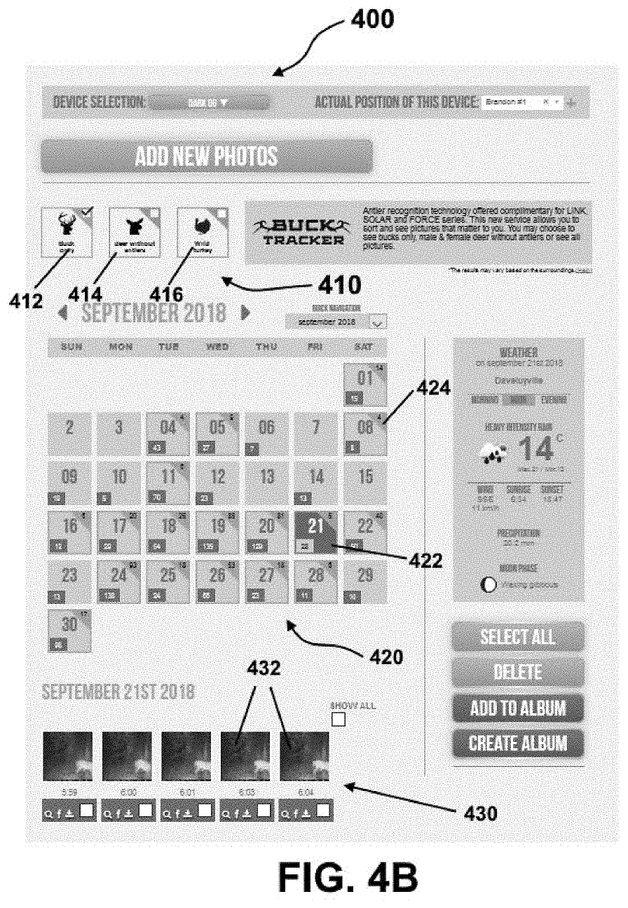

Now referring to FIGS. 4A and 4B, an interface showing the captured images with detected animals 400 is shown. The interface 400 may comprise a module for filtering species and/or characteristics (filtering module) 410, a calendar showing captured photos by date 420, a photo gallery 430 of images captured for the applied filters and/or specific dates and/or a module to manually upload images 440.

The calendar 420 typically comprises the number of images captured and with an animal detected 422. As shown in FIG. 4B, when one or more filter 410 is applied, the calendar 420 comprises the number of images classified with such features 424.

The filter module 410 may comprise a plurality of individual filters to be applied, each individual filter representing a species and/or a characteristic of an animal. As an example, in FIG. 4B, the individual filters are dear with buck 412, deer without antlers 414 and wild turkey 416.

The photo gallery 430 may be configured to show only images 432 within the applied individual filters 410. As an example, the FIG. 4B shows only the images from September 21 showing bucks 432.

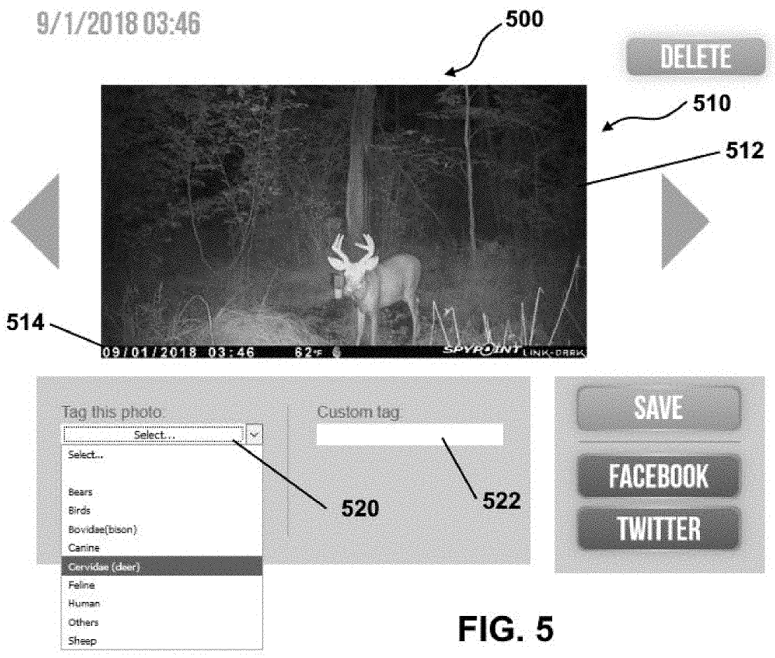

Referring now to FIG. 5, an interface showing an image comprising a classified animal 500 is shown. The interface 500 may comprise an image display portion 510 and/or a tagging module 520, 522. The image display portion 510 typically comprises a view of the image 512 and is configured to display parameters or environmental conditions of the captured image 512. The tagging module 520, 522 may be configured for a user to classify the image using one of the predetermined tags 520. Such classification may be used by the system 100 to train the classification module 23. The interface 500 may further comprise a custom tag module 522 configured for a user to add personalized tags.

The present disclosure refers to animal and characteristics of animal, however, it should be understood that the present invention may be used with other moving objects, such as vehicles and humans without departing from the scope of the present invention. Understandably, the characteristics to be detected or classified for other moving objects or humans shall be selected based on the type of moving object.

In other embodiments, the camera 10 may be a video camera adapted to capture either series of photographs or videos. Understandably, the present system and methods may be used and adapted to detect and classifies animals in series of photographs or videos.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system for automatically identifying and classifying a moving object in one or more images, the system comprising:
a data network;
an image capturing device installed to capture the one or more images of a scene at predetermined times, the image capturing device comprising:
a storage module configured to store the one or more captured images;
a communication module configured to wirelessly communicate a remotely accessible computing device through the network;
a remotely accessible computing device comprising a storage module, the remotely accessible computing device being configured to:
to receive the one or more images captured by the image capturing device;
to detect an animal in the received one or more images;
to classify the detected moving object to identify characteristics and/or type of the detected moving object by calculating a probability of the characteristics and/or type of the detected moving object to be present in the one or more captured images.

2. The system of claim 1, the system further comprising one or more client computerized devices, each client computerized device being configured to communicate with the remotely accessible computing device through the network, the remotely accessible computing device being further configured to send a notification upon identifying characteristics and/or type of the detected moving object.

3. The system of claim 2, the remotely accessible computer device being further configured to send the notification when the calculated probability is higher than a predetermined level.

4. The system of claim 3, each client computerized device being further configured to download the one or more classified images.

5. The system of claim 4, each client computerized device being further configured to filter the one or more classified image based on an identified characteristic and/or on an identified type.

6. The system of claim 1, the remotely accessible computing device further comprising a machine learning module, the machine learning module being configured to store a large number of preselected images for which a moving object has been identified to train the classification of the detected moving object.

7. The system of claim 6, the training of the detected moving object being further configured to vary parameters of detections and to proceed to a large number of iterations by comparing the variation of parameters with the moving identified in the preselected images.

8. The system of claim 1, the image capturing device comprising a movement detector adapted to detect movement in the scene to be captured, the detection of movement triggering the image capturing device to capture an image of the scene.

9. The system of claim 5, the moving object being an animal and the type being a species.

10. The system of claim 5, the image capturing device being a digital camera.

11. A computer-implemented method for automatically identifying and classifying a moving object in one or more image, the method comprising:
capturing the one or more digital images of a scene using an image capturing device;
communicating the captured image to a remote server;
the remote server pre-processing the transmitted image;
the remote server sending an image reception confirmation to the image capturing device;
detecting presence of the moving object in the one or more communicated image;
classifying the detected moving object to identify characteristics and/or type of the detected moving object by calculating a probability of the characteristics and/or type of the detected moving object to be present in the one or more captured images.

12. The method of claim 11, the method further comprising:
detecting movement in the scene;
capturing the one or more image only if movement is detected.

13. The method of claim 12, the method further comprising wirelessly communicating the stored images to the remote server at predetermined times upon detecting movement in the scene.

14. The method of claim 11, the method further comprising:
storing the one or more captured images to a storage unit of the image capturing device;
wirelessly communicating the stored images to the remote serve at predetermined times.

15. The method of claim 11, the method further comprising:
validating if the captured image respects minimum requirements for detection; and
sending a command to the image capturing device to correct the one or more identified parameters of capturing process.

16. The method of claim 11, the method further comprising sending a notification of an identified type and/or characteristic of the moving object to a remote client device.

17. The method of claim 11, the classification of the detected moving object being automatically trained by a machine learning module.

18. The method of claim 17, The method further comprising storing a large number of preselected images for which a moving object has been identified to train the classification of the detected moving object.

19. The system of claim 18, the method further comprising:
varying parameters of classification and identification; and
proceeding to a large number of iterations by comparing the variation of parameters with the moving identified in the preselected images.

20. The system of claim 19, the method further comprising:
rating the one or more classified image as to the presence of the identified types or characteristics of the detected moving object;
automatically adding the image having a positive rating to the preselected images for training purposes.
